(19) United States
(12) Patent Application Publication
(10) Pub. No.: US 2016/0024679 A1
(43) Pub. Date: Jan. 28, 2016

(54) TURBINE ENGINE COMPONENT WITH A DIFFUSED CHROMIUM LAYER

(71) Applicant: CSA GROUP LLC, Port St. Lucie, FL (US)

(72) Inventors: William D. HURST, Fort Pierce, FL (US); Glenn E. CAUTHREN, Palm City, FL (US)

(73) Assignee: CSA GROUP LLC, Port St. Lucie, FL (US)

(21) Appl. No.: 14/716,096

(22) Filed: May 19, 2015

Related U.S. Application Data
(60) Provisional application No. 62/029,517, filed on Jul. 27, 2014.

(51) Int. Cl. C25D 7/06; F01D 5/28; C25D 7/04; C25D 3/66; C25D 11/38

(52) U.S. Cl. CPC C25D 7/0692; C25D 3/66; C25D 11/38; C25D 7/04; F01D 5/288; F05D 2300/132

(57) ABSTRACT

Turbine blades, including airfoils, of aviation or industrial gas turbine engines are treated with chromium to improve resistance to hot corrosion. Various alloys, including, but not limited to nickel, cobalt, molybdenum, and stainless steel alloys may be treated with chromium. Chromium is introduced through the surface and into the material by a process of electrolytic molten salt deposition. This treatment produces components with increased chromium content and improved resistance to hot corrosion caused by airborne sodium salts entering the turbines.

### PRIORITY CLAIM

This application claims priority to U.S. Provisional Application No. 62/029,517 filed Jul. 27, 2014, the contents of which are herein incorporated by reference.

### BACKGROUND OF THE INVENTION

Typically, a gas turbine engine consists of a series of rotating and stationary airfoil components arranged in two main areas: the compressor, or ‘cold’ section, and the turbine, or ‘hot’ section. Air drawn into the forward cold section is compressed as it passes over the airfoils and is forced into the hot section in which fuel is injected and combustion occurs. During combustion in a gas turbine engine, sulfur from the fuel may react with sodium chloride from ingested air at elevated temperatures to form sodium sulfate. The sodium sulfate then deposits on the hot-section components, such as nozzle guide vanes and rotor blades, resulting in an accelerated oxidation (or sulfidation) attack. This is commonly referred to as “hot corrosion.”

### SUMMARY OF THE INVENTION

According to an exemplary embodiment, a turbine component, including, but not limited to, rotor blades, nozzle guide vanes, compressor vanes, turbine vanes, and turbine nozzle rings of gas turbine engines may be treated with chromium to improve resistance to hot corrosion and/or durability. The chromium treatment may utilize an electrolytic molten salt deposition method and may allow a chromium coating to be deposited onto and diffused into a layer at the surface of the turbine component. A variety of alloy components, including nickel, cobalt, molybdenum, and stainless steel may be treated with chromium. This treatment may produce components with increased resistance to hot corrosion, including sulfidation that may or may not be caused by sodium chloride, and thereby extending the life of the components.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 may show a rotor blade having a surface treated with chromium so as to improve the corrosion resistance of the component.

FIG. 2 may shows a nozzle guide vane having a surface treated with chromium so as to improve the corrosion resistance of the component.

FIG. 3 may show a compressor vane having a surface treated with chromium so as to improve the corrosion resistance of the component.

FIG. 4 may show a turbine vane having a surface treated with chromium so as to improve the corrosion resistance of the component.

FIG. 5 may show part of a turbine nozzle ring having a surface treated with chromium so as to improve the corrosion resistance of the component.

FIG. 6 may show a cross-section of a portion of a component treated with chromium to illustrate the result of chromium treatment.

FIG. 7 may show a cross-section of a portion of a component treated with chromium to illustrate the result of chromium treatment.

FIG. 8 may show an illustration of the electrolytic molten salt deposition.

FIG. 9 may show an illustration of a method of increasing the corrosion resistance of a turbine element of a gas turbine engine.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

According to an exemplary embodiment, a turbine component, including rotor blades, nozzle guide vanes, compressor vanes, turbine vanes, and turbine nozzle rings, of gas turbine engines may be treated with chromium to improve resistance to hot corrosion and/or durability.

According to another exemplary embodiment, turbine components made of alloy including, but not limited to, cobalt, nickel, molybdenum and stainless steel alloy may be treated with chromium. This treatment with chromium may produce components with increased resistance to hot corrosion, including sulfidation that may or may not be caused by sodium chloride, thereby extending the life of the components.

Sulfidation is a chemical process that may occur in high temperature environments, and may be of two types: Type I, or high-temperature hot corrosion, generally occurs in the temperature range of 800 to 950° C. (1470 to 1740° F.). A molten sodium sulfate deposit may initiate a hot corrosion attack. The morphology of type I hot corrosion may typically be characterized by a thick, porous layer of oxides covering the underlying alloy matrix depleted in chromium, followed by internal chromium-rich sulfides. Type II hot corrosion, or low-temperature hot corrosion, may generally occur in the temperature range of 670 to 750° C. (1238 to 1382° F.). Type II hot corrosion may be characterized by a pitting attack with little or no internal attack underneath the pit. Cobalt-based alloys may be more susceptible to Type II hot corrosion, which may involve Na₂SO₄ and CoSO₄.

Studies show hot corrosion resistance of various nickel and cobalt alloys at temperatures from 870 to 1040° C. (1600 to 1900° F.) with 5 ppm sea-salt injection. For instance, it can be seen that nickel based alloys may have a satisfactory sulfidation resistance if their chromium content is 12% by weight or more. Evidences may also suggest that alloys with 15% chromium or less may be very susceptible to hot corrosion attack. Cobalt-based alloys may generally show better resistance to corrosion than nickel-based alloys. This may be due to higher chromium contents in cobalt-based alloys. Data shows a proportional relationship, or direct variation, between resistance to corrosion and increased chromium content and suggests that increasing chromium content in the alloy may significantly improve resistance to hot corrosion.

In an exemplary embodiment, increasing the chromium percentage in turbine hot section component alloys may improve the resistance of the material to both Type I and Type II hot corrosion attacks.

In an exemplary embodiment, the alloy used in gas turbine engine components may be exposed to temperatures of approximately 670 to 1040° C. (1238 to 1900° F.). The alloy may have a sufficient chromium content to exhibit increased sulfidation resistance. However, an alloy with a total high chromium content may have structural difficulties including possible embrittling sheet like topologically close packed (TPU) phases with other alloy elements. That is why it may be desirable to attain a protective content of chromium of approximately 5% to approximately 100%, near the surface of the component, where the hot corrosion occurs, while maintaining a lower content of chromium everywhere else. The lower chromium content away from the surface may help to maintain the integrity and structural property of the alloy. This may be achieved by chromium diffusion through the surface of the turbine component.

In an exemplary embodiment, diffusing chromium only into the surface of the turbine component may confine the added weight percentage of chromium to the surface, and may eliminate problems associated with the component's structural integrity that may occur if the chromium were uniform throughout the component.

In an exemplary embodiment, in order to control the alloying results and prevent un-wanted metallurgical interactions, “aerospace chromium” with at least a 99.99% purity may be used. The diffusion coating may also remain ductile at elevated temperatures to accommodate thermal stresses.

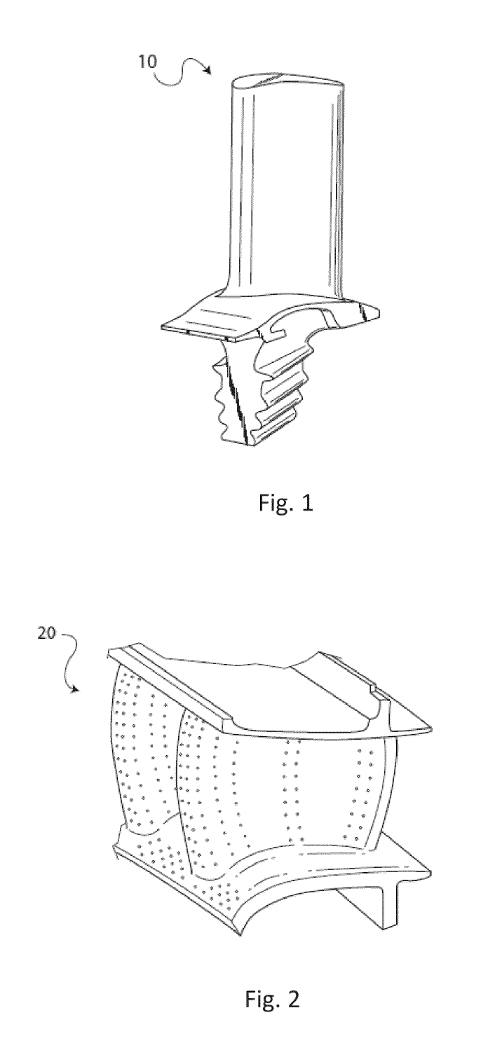

In one exemplary embodiment of the invention, a rotor blade 10, shown in FIG. 1 may be constructed out of cobalt-based alloys or nickel-based alloys. Both cobalt-based alloy blades and nickel-based alloy blades may be treated by the same processes to achieve the improved corrosion resistance and durability. The rotor blades may be those of the type used in hot sections of a gas turbine engine. This type of engine, and turbine, may be used in aviation and industrial applications, but may not be limited to such uses.

In another exemplary embodiment of the invention, a nozzle guide vane 20, shown in FIG. 2 may be constructed out of alloy including, but not limited to, cobalt, nickel, molybdenum and stainless steel alloy. The nozzle guide vane may be treated by the same chromium treatment processes to achieve the improved corrosion resistance and durability. The nozzle guide vanes may be those of the type used in hot sections of a gas turbine engine. This type of engine, and turbine, may be used in aviation and industrial applications, but may not be limited to such uses.

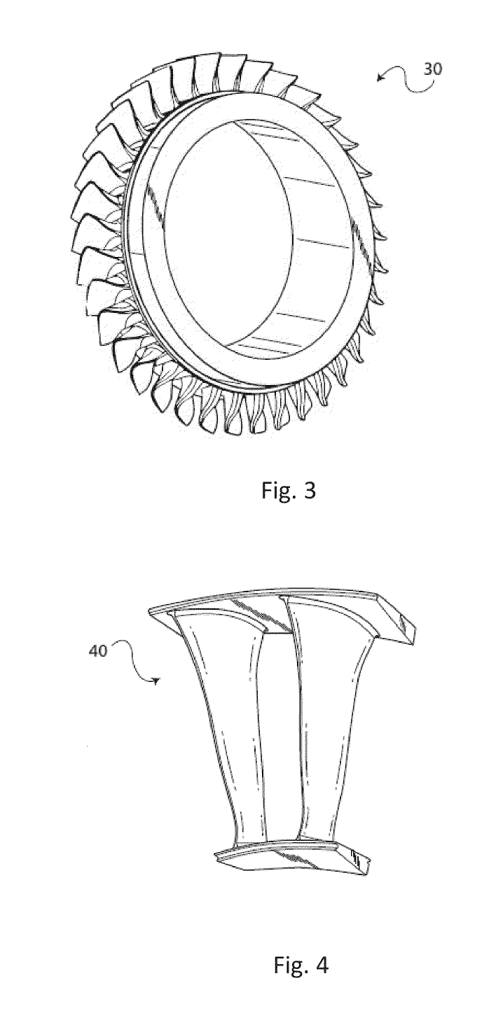

In another exemplary embodiment of the invention, a turbine nozzle ring 30, as shown in FIG. 3, may be constructed out of alloy including, but not limited to, cobalt, nickel, molybdenum and stainless steel alloy. The turbine nozzle ring 30 may be treated by the same chromium treatment process to achieve the improved corrosion resistance and durability. Additionally, the Turbine nozzle ring 30 may be those of the type used in hot sections of a gas turbine engine. This type of engine, and turbine, may be used in aviation and industrial applications, but may not be limited to such uses.

In another exemplary embodiment of the invention, a compressor vane 40, shown in FIG. 4 may be constructed out of alloy including, but not limited to, cobalt, nickel, molybdenum and stainless steel alloy. The compressor vane 40 may be treated by the same chromium treatment process to achieve improved corrosion resistance and durability. Furthermore, the compressor vane 40 may be of the type used in the compressor section of a gas turbine engine. This type of engine, and turbine, may be used in aviation and industrial applications, but may not be limited to such uses.

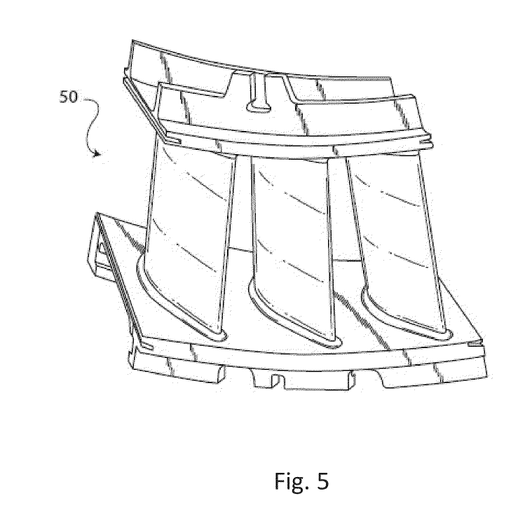

In another exemplary embodiment of the invention, a turbine vane 50, shown in FIG. 5 may be constructed out of alloy including, but not limited to, cobalt, nickel, molybdenum and stainless steel alloy. The turbine vane 50 may be treated by the same chromium treatment process to achieve improved corrosion resistance and durability. Moreover, the turbine vanes 50 may be of the type used in hot sections of a gas turbine engine. This type of engine, and turbine, may be used in aviation and industrial applications, but may not be limited to such uses.

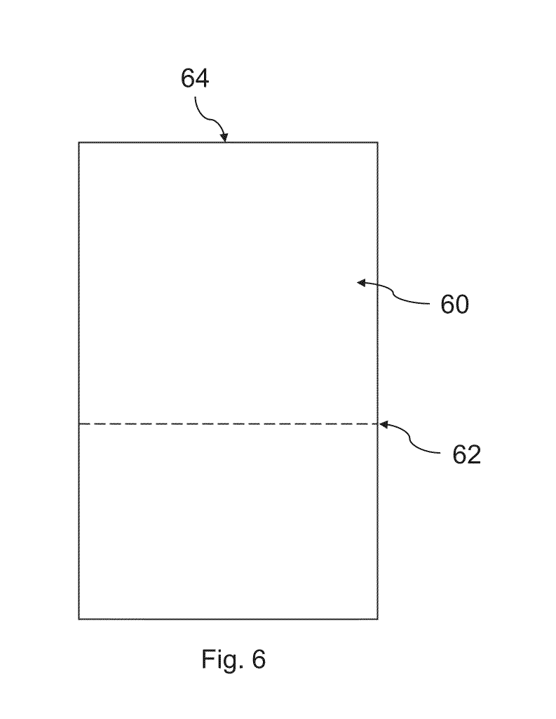

In an exemplary embodiment, a percentage of chromium may be controlled near the surface of a turbine component. In an additional exemplary embodiment, the percentage of chromium maybe controlled to a depth of approximately 5 micrometers or more. The controlled percentage of chromium may range from approximately 5% to approximately 100%. This control of the chromium percentage may be achieved by careful selection of current density, temperature, time and to some extent pressure within the reactor. As shown in FIG. 6, the deposit 60, regardless of the final surface percentage of chromium, may gradually increase from 0% just below the diffusion layer 62 to a targeted percentage at the surface 64.

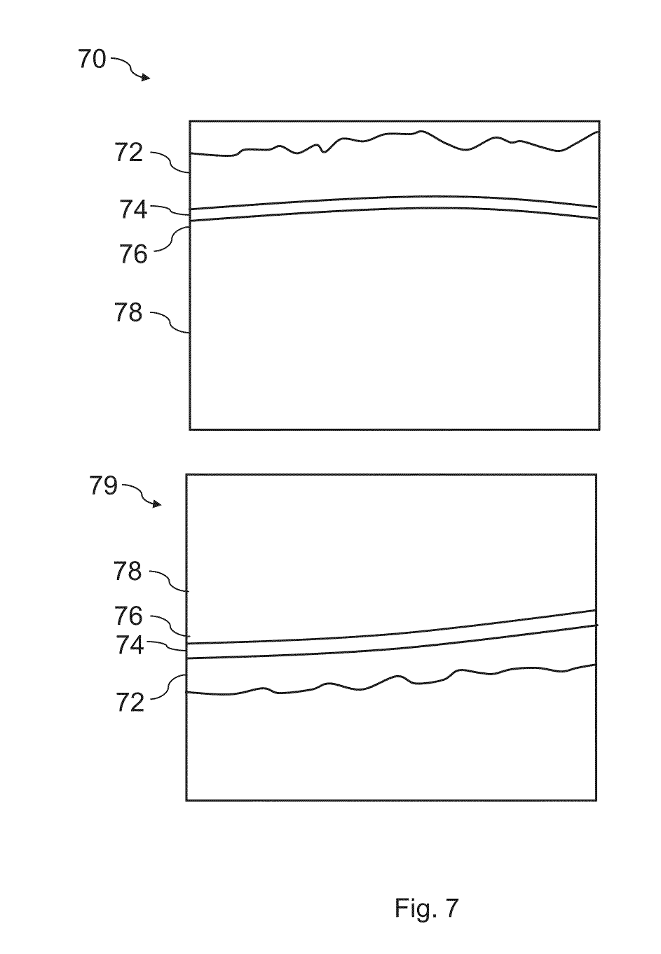

An exemplary embodiment is illustrated in FIG. 7, a cross section view reveals the percentage of chromium in the layer of material below the surface of the component. Analysis of a scanning electron microscopy image 70 features a 50 micrometers deposit 72 on the surface with weight percentages of chromium of approximately 98.69% to approximately 99.24%. Measurement on the layer of material 25 microns deep, just below the surface 74, shows weight percentages of chromium of approximately 98.70%. The analysis also shows a nucleation layer 76 of approximately 8 micrometers thick with weight percentages of chromium of approximately 61.82% and weight percentages of nickel of approximately 38.18%. Finally, measurement of the composition at a greater depth in the material 78 indicates weight percentages of chromium of approximately 0.23%. An optical image of the cross section 79 confirms the layer morphology observed in the SEM image.

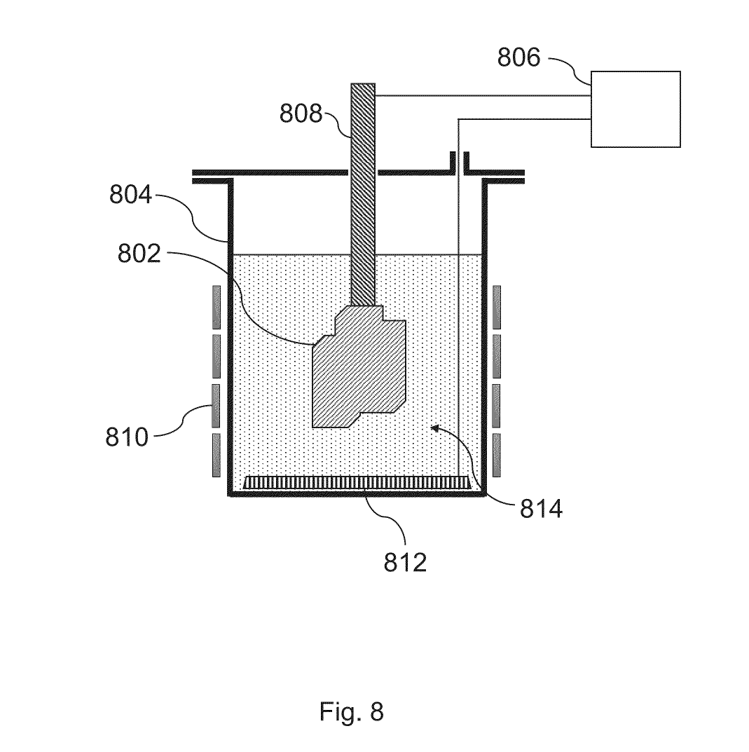

In an exemplary embodiment illustrated in FIG. 8, the chromium treatment may include an electrolytic molten salt deposition step, and may allow a chromium coating to be deposited onto and diffused into a turbine component. The electrolytic molten salt deposition may take place in a pressurized reactor 804 surrounded by heating elements. The turbine component 802 may be attached to an electrode 808 and plunged into molten electrolyte 814. A second electrode may be connected to the power supply 806 and may be sunk in the molten electrolyte to complete the electrical circuit.

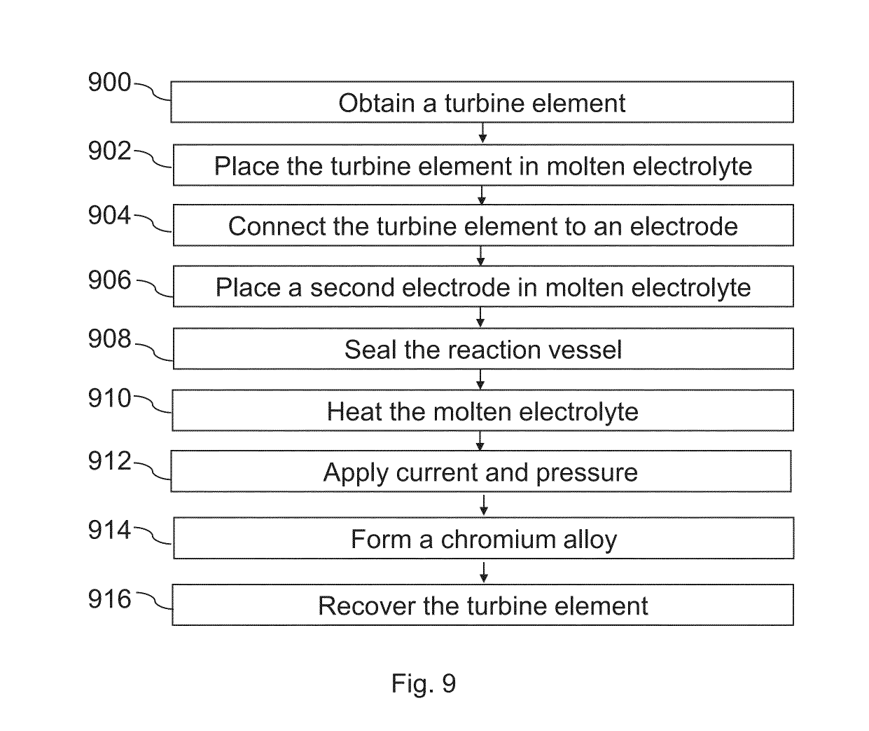

In another exemplary embodiment a method of increasing the-corrosion resistance of a turbine element of a gas turbine engine may be provided and described in FIG. 9. A turbine element may be obtained 900, then placed in molten electrolyte 902. The turbine element may be connected to an electrode 904 and a second electrode may be placed in the same molten electrolyte 906. The reaction vessel (or reactor) may be sealed 908 and the molten electrolyte may be heated 910. At that point, electrical current and pressure may be applied 912 and the chromium alloy may be formed. Finally, the turbine element may be recovered 916.

In another exemplary embodiment, the chromium treatment of the rotor blades may be accomplished via electrolytic molten salt deposition methods. The electrolytic molten salt deposition methods may utilize potassium, lithium, sodium, calcium and cesium molten fluorides and chlorides. The chemistry of the fluorides and/or chlorides, the salt bath temperature, the internal reactor pressure, the time, the alloy content of the substrate and the current density utilized may be dependent on the desired chromium percentage, rate of deposition and thickness of the final coating. This process may require an electrolyte temperature of between 850° F. and 1850° F., current densities between 50 to 500 mA/in2, and reactor internal pressure between 1 and 3 atmospheres.

In another exemplary embodiment, the result of the process may increase resistance to type I and type II hot corrosion that may increase the working life of the rotor blade. Alternative coating processes such as electroplating, laser cladding, vapor deposition and others may fail at providing protection partly due to their inability to form a true mixture of chromium and a base alloy at the boundary layer. Without this diffusion, the cycle of cold/hot/cold, the contraction and expansion cycle, and the intense forces within a gas turbine engine may cause the chromium deposits to de-laminate, break loose and fail.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A turbine element for a gas turbine engine comprising:
a base metal treated with chromium so as to form a chromium alloy to a predetermined depth from a surface of the turbine element.

2. The turbine element of claim 1, wherein the turbine element comprises at least one of a rotor blade, a nozzle guide vane, a compressor vane, a turbine vane, and a turbine nozzle ring.

3. The turbine element of claim 1, wherein the base metal comprises at least one of a cobalt-based alloy, a nickel-based alloy, a molybdenum based alloy, and a stainless steel alloy.

4. The turbine element of claim 1, wherein a purity of the chromium is at least 99.99%.

5. The turbine element of claim 1, wherein the chromium alloy comprises approximately 5% to approximately 100% of chromium to the predetermined depth.

6. The turbine element of claim 5, wherein the predetermined depth is at least 5 micrometers.

7. A method of increasing the corrosion resistance of a turbine element of a gas turbine engine comprising:
obtaining a turbine element comprised of a base metal;
treating a surface of the base metal with chromium; and
forming a chromium alloy between the base metal and the chromium to a predetermined depth from the surface.

8. The method of claim 7, wherein the turbine element comprises at least one of a rotor blade, a nozzle guide vane, a compressor vane, a turbine vane, and a turbine nozzle ring.

9. The method of claim 7, wherein the base metal comprises at least one of a cobalt-based alloy, a nickel-based alloy, a molybdenum based alloy, and a stainless steel alloy.

10. The method of claim 7, wherein the chromium alloy comprises approximately 5% to approximately 100% of the chromium to the predetermined depth.

11. The method of claim 10, wherein the predetermined depth is at least 5 micrometers.

12. The method of claim 7, wherein treating a surface of the base metal with chromium further comprises:
an electrolytic molten salt deposition process.

13. The method of claim 12, wherein the electrolytic molten salt deposition process comprises:
heating an electrolyte;
applying a current; and
applying a pressure.

14. The method of claim 13, wherein the electrolyte comprises at least one of chromium, potassium, lithium, sodium, calcium, cesium, fluorides, and chlorides.

15. The method of claim 13, wherein the electrolyte is heated to a temperature of approximately 850° F. to approximately 1850° F.

16. The method of claim 13, wherein the current density is between approximately 50 to approximately 500 mA/in².

17. The method of claim 13, wherein the pressure is between approximately 1 to approximately 3 atmospheres.
